(19) United States
(12) Patent Application Publication
(10) Pub. No.: US 2025/0358407 A1
(43) Pub. Date: Nov. 20, 2025

(54) VIDEO ENCODING METHOD AND APPARATUS, ELECTRONIC DEVICE, AND STORAGE MEDIUM

(71) Applicant: Tencent Technology (Shenzhen) Company Limited, Shenzhen (CN)

(72) Inventor: Jia ZHANG, Shenzhen (CN)

(21) Appl. No.: 19/281,289

(22) Filed: Jul. 25, 2025

Related U.S. Application Data
(63) Continuation of application No. PCT/CN2024/094373, filed on May 21, 2024.

(30) Foreign Application Priority Data
May 23, 2023 (CN) 202310587690.4

(51) Int. Cl. H04N 19/11; H04N 19/119; H04N 19/147; H04N 19/176; H04N 19/593

(52) U.S. Cl. CPC H04N 19/11; H04N 19/119; H04N 19/147; H04N 19/176; H04N 19/593

(57) ABSTRACT

Disclosed are a video encoding method performed by an electronic device. The method includes: determining prediction unit (PU) distribution information of an image block in which a current PU is located; determining a unit category of a current PU according to the PU distribution information of the image block; determining an intra-frame prediction mode of the current PU according to the unit category of the current PU; and encoding the image block using the current PU according to the determined intra-frame prediction mode. According to the embodiments of this application, the intra-frame prediction mode of the PU can be rapidly determined, to improve video encoding efficiency.

### CROSS-REFERENCE TO RELATED APPLICATIONS

This application is a continuation application of PCT Patent Application No. PCT/CN2024/094373, entitled “VIDEO ENCODING METHOD AND APPARATUS, ELECTRONIC DEVICE, AND STORAGE MEDIUM” filed on May 21, 2024, which claims priority to Chinese Patent Application No. 202310587690.4, entitled “INTRA-FRAME PREDICTION MODE DETERMINATION METHOD AND APPARATUS, DEVICE, AND STORAGE MEDIUM” filed with the China National Intellectual Property Administration on May 23, 2023, both of which are incorporated herein by reference in their entirety.

### FIELD OF THE TECHNOLOGY

This application relates to the field of computer technologies, and in particular, to a video encoding method and apparatus, an electronic device, and a storage medium.

### BACKGROUND OF THE DISCLOSURE

With the rapid development of Internet technologies, videos have been widely used, and has gradually replaced text to become an important manner for acquiring knowledge and information. During video transmission, because a volume of video data is relatively large, the video data usually needs to be encoded into a video bitstream by using a video encoding technology, and then the video bitstream is transmitted. Before the video data is encoded, each video frame is partitioned into a plurality of coding units (CU), and the CUs are encoded. In addition, an important link of encoding a CU is determining an intra-frame prediction mode of each prediction unit (PU) in the CU, to perform intra-frame predictive encoding on the PU according to the corresponding intra-frame prediction mode.

In the related art, generally, all available intra-frame prediction modes are traversed for each PU, to determine an optimal intra-frame prediction mode, and intra-frame predictive encoding is performed on the corresponding prediction unit. However, the method involves relatively large computing amount, and relatively low efficiency in determining the intra-frame prediction mode, leading to low overall video encoding efficiency.

### SUMMARY

Embodiments of this application provide a video encoding method and apparatus, an electronic device, and a storage medium, which can rapidly determine an intra-frame prediction mode of a prediction unit (PU), to improve video encoding efficiency.

In an aspect, the embodiments of this application provide a video encoding method performed by an electronic device, which includes:
determining PU distribution information of an image block in which a current PU is located;
determining a unit category of the current PU according to the PU distribution information of the image block;
determining an intra-frame prediction mode of the current PU according to the unit category of the current PU; and
encoding the image block using the current PU according to the determined intra-frame prediction mode.

In another aspect, the embodiments of this application provide an electronic device, which includes a processor and a memory, the processor being connected to the memory;
the memory being configured to store a computer program; and
the processor being configured to perform, when invoking the computer program, the video encoding method provided in the embodiments of this application.

In another aspect, the embodiments of this application provide a non-transitory computer-readable storage medium, which has a computer program stored therein. A processor executes the computer program to implement the video encoding method provided in the embodiments of this application.

In the embodiments of this application, after the unit category of the current PU is determined according to the PU distribution information of the image block in which the current PU is located, the intra-frame prediction mode of the current PU may be directly determined according to the unit category of the current PU, whereby a proportion of intra-frame predictive encoding in video encoding complexity is effectively reduced, video coding efficiency is improved, computing resources are saved, and high applicability is achieved.

### BRIEF DESCRIPTION OF THE DRAWINGS

To describe the technical solutions in the embodiments of this application or more clearly, the accompanying drawings required for describing the embodiments are briefly described below. Apparently, the accompanying drawings in the following descriptions are merely some embodiments of this application, and those of ordinary skill in the art may further derive other drawings from the accompanying drawings without involving creative efforts.

FIG. 1 is a schematic architectural diagram of a video encoding system according to an embodiment of this application.

FIG. 2 is a schematic flowchart of a video encoding method according to an embodiment of this application.

FIG. 3A is a first schematic diagram of a preset relative position according to an embodiment of this application.

FIG. 3B is a second schematic diagram of a preset relative position according to an embodiment of this application.

FIG. 3C is a third schematic diagram of a preset relative position according to an embodiment of this application.

FIG. 4A is a first schematic diagram of a prediction unit (PU) distribution according to an embodiment of this application.

FIG. 4B is a second schematic diagram of a PU distribution according to an embodiment of this application.

FIG. 5 is a schematic diagram of a distribution of a directional prediction mode according to an embodiment of this application.

FIG. 6 is a schematic block diagram of a process of determining a unit category according to an embodiment of this application.

FIG. 7 is a schematic block diagram of a process of determining an intra-frame prediction mode according to an embodiment of this application.

FIG. 8 is a schematic structural diagram of a video encoding apparatus according to an embodiment of this application.

FIG. 9 is a schematic structural diagram of an electronic device according to an embodiment of this application.

### DESCRIPTION OF EMBODIMENTS

The technical solutions in the embodiments of this application are clearly and completely described in the following with reference to the accompanying drawings in the embodiments of this application. Apparently, the described embodiments are merely some rather than all of the embodiments of this application. All other embodiments obtained by those of ordinary skill in the art based on the embodiments of this application without involving creative efforts fall within the scope of protection of this application.

FIG. 1 is a schematic architectural diagram of a video encoding system according to an embodiment of this application. As shown in FIG. 1, the video encoding system may include a terminal device 100, a terminal device 200, and a server 300. The terminal device 100 and the terminal device 200 may communicate with the server 300 over a wired or wireless network. The terminal device 200 or the terminal device 100 may determine an intra-frame prediction mode of each prediction unit (PU) by using a video encoding method provided in the embodiments of this application, perform intra-frame predictive encoding according to the determined intra-frame prediction mode, and further transmit a finally obtained encoded data stream to the server 300, and the encoded data stream is transmitted to another corresponding terminal device.

The architecture shown in FIG. 1 is merely an example, and does not constitute a limitation on the embodiments of this application. In practical application, a number of terminal devices and a number of servers may be different from those shown in FIG. 1.

The terminal device 100 and the terminal device 200 may be, but is not limited to, a personal computer, a notebook computer, a smartphone, a tablet computer, a smartwatch, an intelligent voice interaction device, a smart home appliance, an on-board terminal, a smart wearable device, or the like. The server 300 may be an independent physical server, or may be a server cluster or distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), a big data and artificial intelligence platform.

The video encoding method provided in the embodiments of this application may be performed by the terminal device 100 or the terminal device 200, or may be cooperatively performed by any terminal device and the server 300. This is not limited in the embodiments of this application.

Further, the video encoding method provided in the embodiments of this application may be applied to versatile video coding (VVC)/H.266, high efficiency video coding (HEVC)/H.265, or a next-generation video coding/decoding standard. This is not limited in the embodiments of this application.

The HEVC standard is also referred to as the H.265 coding/decoding standard, and may be adopted to extend the H.264/AVC coding/decoding standard. The standard specifies an encoding/decoding process and related syntax of stream data corresponding to H.265. The VVC standard is also referred to as the H.266 coding/decoding standard, and specifies an encoding/decoding process and related syntax of stream data corresponding to H.266.

The foregoing standards incorporate many key technologies to improve performance, such as a quadtree-based coding unit (CU) partitioning technology, an intra-frame prediction technology with a finer prediction direction, an inter-frame prediction technology that adopts a motion merging technology and an advanced motion vector prediction mode, a high-precision motion compensation technology, and a deblocking filtering and pixel adaptive compensation technology configured to improve quality of a reconstructed image.

A CU is a basic unit for encoding a video frame. During encoding, the CU may refer to an entire video frame (when the video frame is not partitioned), or may refer to a partial area in the video frame (when the video frame is partitioned).

The intra-frame predictive encoding refers to encoding in which a CU is encoded without referring information from any video frame other than a video frame to which the CU belongs.

A PU specifies all prediction modes of the CU, and all prediction-related information is defined in the PU.

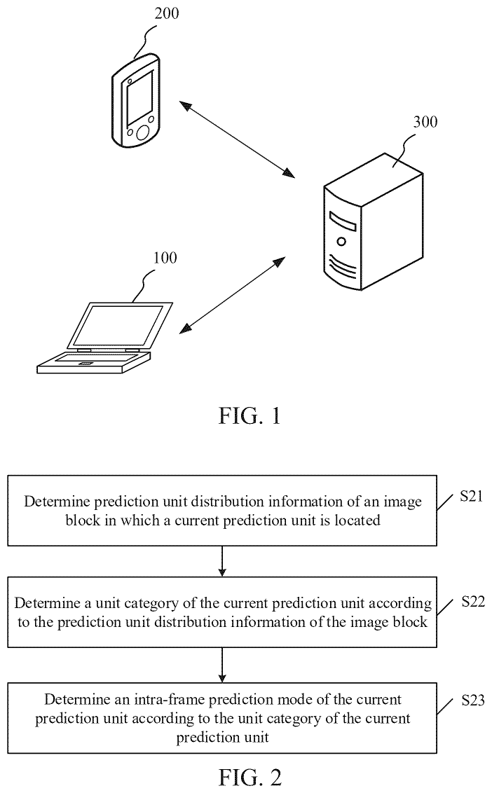

FIG. 2 is a schematic flowchart of a video encoding method according to an embodiment of this application. As shown in FIG. 2, the data encoding method provided in the embodiments of this application may specifically include the following operations.

Operation S21: Determine PU distribution information of an image block in which a current PU is located.

A video frame may be partitioned into at least one coding block, and each coding block is an image block. Each video frame may be partitioned into several non-overlapping CUs, and each CU may further be partitioned into one or more PUs. A method for partitioning a CU includes, but is not limited to, a partitioning method such as flat binary tree partition (a horizontal binary partition for short), a vertical binary tree partition (a vertical binary partition for short), a quadtree partition (a quaternary partition for short), a horizontal ternary tree partition (a horizontal ternary partition for short), and a vertical ternary tree partition (a vertical ternary partition for short). In addition, a method for partitioning a PU may be any partitioning method in the related art. This is not limited herein.

In the embodiments of this application, the current PU is a PU on which intra-frame predictive encoding needs to be currently performed in the image block.

The PU distribution information of the image block in which the current PU is located represents a partitioning method and distribution of PUs in the image block in which the current PU is located.

Operation S22: Determine a unit category of the current PU according to the PU distribution information of the image block.

In some feasible implementations, PUs belonging to different unit categories correspond to different video encoding methods. Therefore, before an intra-frame prediction mode of the current PU is determined, the PU distribution information of the image block in which the current PU is located needs to be first determined, and then, the unit category of the current PU is determined.

In some feasible implementations, when the unit category of the current PU is determined according to the PU distribution information of the image block in which the current PU is located, whether a PU exists at each preset relative position with respect to the current PU in the image block in which the current PU is located may be first determined according to the PU distribution information of the image block in which the current PU is located.

For the current PU, a PU located at each preset relative position of the current PU in the image block may be referred to as a neighborhood PU of the current PU.

The preset relative position may be any one or more positions that are adjacent to the current PU and on which intra-frame predictive encoding has been performed in “Z”-type encoding order specified by a coding standard, and may be specifically determined based on requirements of a practical application scenario. This is not limited herein. That is, the PU at each preset relative position in the image block is subjected to intra-frame predictive encoding prior to the current PU and is adjacent to the current PU.

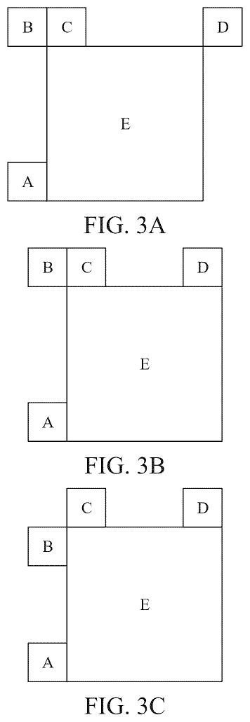

As an example, if the current PU is E, preset relative positions corresponding to the current PU E are positions shown as A, B, C, and D in FIG. 3A to FIG. 3C. The preset relative positions shown in FIG. 3A to FIG. 3C are merely examples, and are not limited in the embodiments of this application.

Since different CUs may be partitioned into PUs in different ways, and the current PU in the image block may be located at an edge position, for each preset relative position of the current PU, a neighborhood PU of the current PU may exist or may not exist at the preset relative position in the image block in which the current PU is located. In addition, for a plurality of preset relative positions of the current PU, the plurality of preset relative positions of the current PU in the image may correspond to a same neighborhood PU.

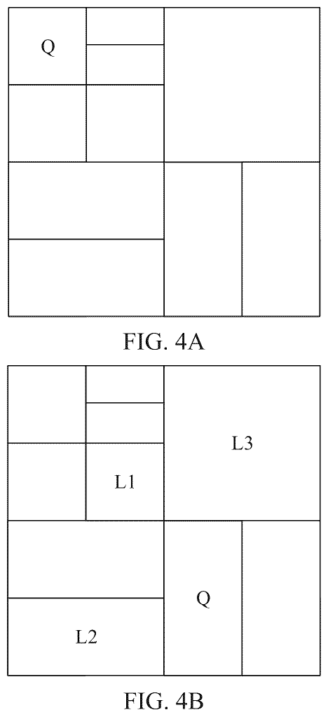

As an example, if a position (a PU Q) of the current PU in the image block is shown in FIG. 4A, no neighborhood PU of the current PU exists in the image block shown in FIG. 4A when the preset relative position corresponding to the current PU is shown in FIG. 3A.

As an example, if a position (a PU Q) of the current PU in the image block is shown in FIG. 4B, a prediction unit L1, a prediction unit L2, and a prediction unit L2 in the image block shown in FIG. 4B are neighborhood PUs of the current PU when the preset relative position corresponding to the current PU is shown in FIG. 3A.

Based on the foregoing implementation, whether a neighborhood PU of the current PU exists at each preset relative position with respect to the current PU in the image block may be determined according to the PU distribution information of the image block.

In some feasible implementations, when it is determined, according to the PU distribution information of the image block, that the neighborhood PU exists at each preset relative position with respect to the current PU in the image block, because intra-frame predictive encoding has been performed on each neighborhood PU, the unit category of the current PU may be determined according to encoding information of each neighborhood PU. The encoding information of each neighborhood PU includes an intra-frame prediction mode of each neighborhood PU.

In this case, when it is determined, according to the PU distribution information of the image block, that no neighborhood PU exists at at least one preset relative position with respect to the current PU in the image block, it may be determined that the unit category of the current PU is a third category.

As an example, if the current PU is a PU Q in FIG. 4A, because the current PU is located at the upper left corner of the image block, the PU Q is the first PU on which intra-frame predictive encoding is performed in the image block, then it may be determined that no neighborhood PU of the PU Q in the image block, and it may be further determined that the unit category of the PU Q is the third category.

As an example, if the current PU is a PU Q in FIG. 4B, it may be known from the foregoing description that FIG. 4B shows all neighborhood PUs of the PU Q: a PU L1, a PU L2, and a PU L2. Therefore, the unit category of the current PU may be determined based on encoding information of the PU L1, the PU L2, and the PU L2.

Alternatively, when it is determined, according to the PU distribution information of the image block, that the neighborhood PU exists at at least one preset relative position with respect to the current PU in the image block, the unit category of the current PU may be determined according to encoding information of each neighborhood PU.

Based on this, when it is determined, according to the PU distribution information of the image block, that no neighborhood PU exists at each preset relative position with respect to the current PU in the image block, it may be determined that the unit category of the current PU is the third category.

In some feasible implementations, when the unit category of the current PU is determined according to the encoding information of each neighborhood PU, an intra-frame prediction mode of the corresponding neighborhood PU may be first determined according to the encoding information of each neighborhood PU.

The intra-frame prediction mode of each neighborhood PU may be one of a direct current (DC) prediction mode, a planar prediction mode, and a directional prediction mode.

The directional prediction mode in the VVC/H.266 standard include 65 intra-frame prediction modes, and each intra-frame prediction mode corresponds to a direction (angle). The directional prediction mode in the HEVC/H.265 standard include 33 intra-frame prediction modes, and each intra-frame prediction mode also corresponds to a direction (angle).

Each intra-frame prediction mode in any standard corresponds to a unique mode identifier, and the mode identifier includes a direction identifier and a mode serial number identifier.

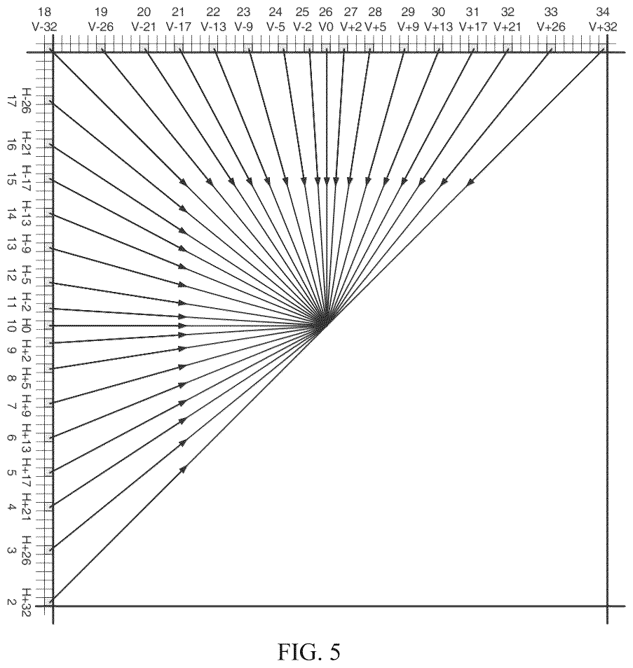

For example, the directional prediction mode in the HEVC/H.265 standard may be shown in FIG. 5. FIG. 5 shows 33 intra-frame prediction modes. In a mode identifier of each intra-frame prediction mode, V indicates a horizontal direction, H indicates a vertical direction, the number added to or subtracted from V or H indicates a direction offset, and a serial number from 2 to 34 indicates a mode serial number. The directional prediction modes are more densely distributed in a horizontal direction and a vertical direction, and a directional angle of each directional prediction mode changes gradually as the number increases.

Further, for the current PU, if it is determined, according to the encoding information of each neighborhood PU, that the intra-frame prediction mode of the corresponding neighborhood PU is the DC prediction mode or the planar prediction mode, it is determined that the unit category of the current PU is a first category.

That is, if the intra-frame prediction mode of each neighborhood PU of the current PU is the DC prediction mode or the planar prediction mode, it may be determined that the unit category of the current PU is the first category.

Further, for the current PU, if it is determined, according to the encoding information of each neighborhood PU, that intra-frame prediction modes of all the neighborhood PUs are directional prediction modes, and a difference between a maximum mode serial number and a minimum mode serial number corresponding to the directional prediction modes of all the neighborhood PUs is less than or equal to a first threshold, it is determined that the unit category of the current PU is a second category.

The mode serial number of the directional prediction mode is the number in the foregoing mode identifier.

On the other hand, for the current PU, if it is determined, according to the encoding information of each neighborhood PU, that the intra-frame prediction modes of all neighborhood PUs include at least two of the DC prediction mode, the planar prediction mode, and the directional prediction mode, it is determined that the unit category of the current PU is the third category.

For example, for the current PU, if it is determined, according to encoding information of neighborhood PUs of the current PU, that intra-frame prediction modes of all the neighborhood PUs include the DC prediction mode and the directional prediction mode, it is determined that the unit category of the current PU is the third category.

For example, for the current PU, if it is determined, according to the encoding information of the neighborhood PUs of the current PU, that the intra-frame prediction modes of all the neighborhood PUs include the planar prediction mode, and the directional prediction mode, it is determined that the unit category of the current PU is the third category.

For example, for the current PU, if it is determined, according to the encoding information of the neighborhood PUs of the current PU, that the intra-frame prediction modes of all the neighborhood PUs include the DC prediction mode, the planar prediction mode, and the directional prediction mode, it is determined that the unit category of the current PU is the third category.

In an embodiment, for the current PU, if it is determined, according to the encoding information of each neighborhood PU, that the intra-frame prediction modes of all the neighborhood PUs are the directional prediction modes, and the difference between the maximum mode serial number and the minimum mode serial number corresponding to the directional prediction modes of all the neighborhood PUs is greater than the first threshold, it is determined that the unit category of the current PU is the third category.

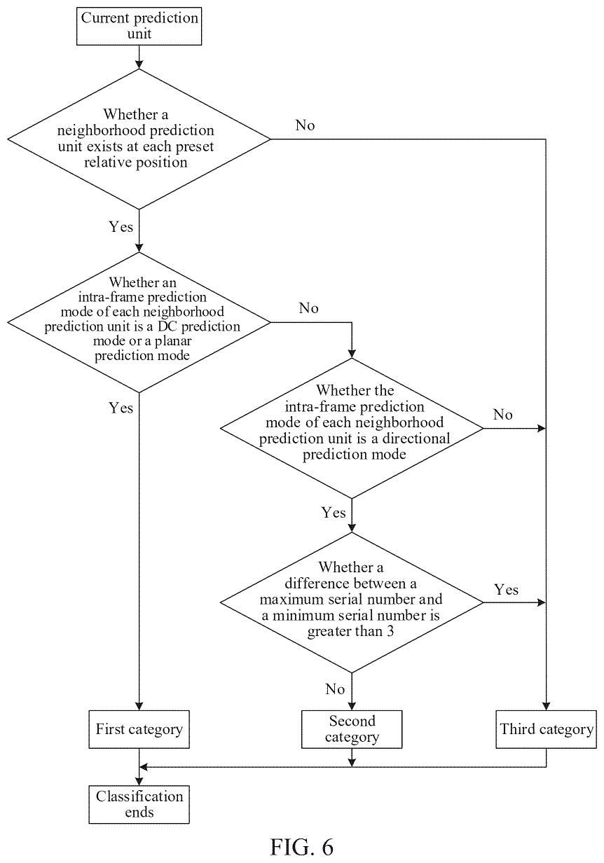

As an example, the following exemplarily describes determination of a unit category of a current PU with reference to FIG. 6. FIG. 6 is a schematic block diagram of a process of determining a unit category according to an embodiment of this application. As shown in FIG. 6, for a current PU:

Operation 1: First, determine PU distribution information of an image block in which the current PU is located, and further, whether a neighborhood PU exists at each preset relative position with respect to the current PU in the image block is determined according to the PU distribution information of the image block.

Operation 1-1: Determine that a unit category of the current PU is a third category if no neighborhood PU exists at at least one preset relative position with respect to the current PU in the image block.

Operation 1-2: Perform operation 2 if the neighborhood PU exists at each preset position with respect to the current PU in the image block.

Operation 2: Determine whether an intra-frame prediction mode of the corresponding neighborhood PU is a DC prediction mode or a planar prediction mode according to encoding information of each neighborhood PU.

Operation 2-1: Determine that the unit category of the current PU is a first category if it is determined, according to the encoding information of each neighborhood PU, that the intra-frame prediction mode of the corresponding neighborhood PU is the DC prediction mode or the planar prediction mode.

Operation 2-2: Perform operation 3 if it is determined, according to the encoding information of each neighborhood PU, that intra-frame prediction modes of all the neighborhood PUs include a directional prediction mode.

Operation 3: Determine whether the intra-frame prediction modes of all the neighborhood PUs are the directional prediction modes.

Operation 3-1: Determine that the unit category of the current PU is the third category if it is determined that the intra-frame prediction modes of all the neighborhood PUs include at least the DC prediction mode and the directional prediction mode, or include at least the planar prediction mode and the directional prediction mode.

Operation 3-2: Perform operation 4 if it is determined that the intra-frame prediction modes of all the neighborhood PUs are the directional prediction modes.

Operation 4: Determine a difference between a maximum mode serial number and a minimum mode serial number corresponding to the directional prediction modes of all the neighborhood PUs, and determine whether the difference is greater than 3 (a first threshold).

Operation 4-1: Determine that the unit category of the current PU is the third category if the difference between the maximum mode serial number and the minimum mode serial number corresponding to the directional prediction modes of all the neighborhood PUs is greater than 3.

Operation 4-2: Determine that the unit category of the current PU is a second category if it is determined that the difference between the maximum mode serial number and the minimum mode serial number corresponding to the directional prediction modes of all the neighborhood PUs is less than or equal to 3.

In the embodiments of this application, for the current PU, if the unit category of the current PU is the first category, it indicates that a texture of an area in which the neighborhood PU of the current PU is located does not have apparent directionality, which further indicates a high possibility that a texture of an area in which the current PU is located does not have apparent directionality.

If the unit category of the current PU is the second category, it indicates that the texture of the area in which the neighborhood PU of the current PU is located has apparent and relatively consistent directionality, which further indicates a high possibility that the texture of the area in which the current PU is located has directionality similar to that of the area in which the neighborhood PU is located.

If the unit category of the current PU is the third category, it indicates that whether the current PU has apparent directionality cannot be determined.

Operation S23: Determine an intra-frame prediction mode of the current PU according to the unit category of the current PU.

After the unit category of the current PU is determined, the intra-frame prediction mode of the current PU may be determined according to a video encoding mode corresponding to the corresponding unit category.

In some feasible implementations, if the unit category of the current PU is the first category, it indicates that the texture of the area in which the neighborhood PU of the current PU is located does not have apparent directionality, which further indicates a high possibility that the texture of the area in which the current PU is located does not have apparent directionality. In this case, rate-distortion costs of the current PU in the DC prediction mode and the planar prediction mode may be determined.

When the rate-distortion cost of the current PU in the DC prediction mode is less than the rate-distortion cost of the current PU in the planar prediction mode, the DC prediction mode is determined as the intra-frame prediction mode of the current PU. When the rate-distortion cost of the current PU in the planar prediction mode is less than the rate-distortion cost of the current PU in the DC prediction mode, the planar prediction mode is determined as the intra-frame prediction mode of the current PU. When the rate-distortion cost of the current PU in the DC prediction mode is equal to the rate-distortion cost of the current PU in the planar prediction mode, the DC prediction mode or the planar prediction mode is determined as the intra-frame prediction mode of the current PU.

In an embodiment, if the unit category of the current PU is the first category, rate-distortion costs of the current PU in the DC prediction mode, the planar prediction mode, a directional prediction mode whose mode serial number is a first serial number, and a directional prediction mode whose mode serial number is a second serial number, respectively, are determined.

When an intra-frame prediction mode having a minimum rate-distortion cost among the DC prediction mode, the planar prediction mode, the directional prediction mode whose mode serial number is the first serial number, and the directional prediction mode whose mode serial number is the second serial number is the DC prediction mode or the planar prediction mode, the intra-frame prediction mode having the minimum rate-distortion cost is determined as the intra-frame prediction mode of the current PU.

For example, when the intra-frame prediction mode having the minimum rate-distortion cost among the DC prediction mode, the planar prediction mode, the directional prediction mode whose mode serial number is the first serial number, and the directional prediction mode whose mode serial number is the second serial number is the DC prediction mode, the DC prediction mode is determined as the intra-frame prediction mode of the current PU.

For example, when the intra-frame prediction mode having the minimum rate-distortion cost among the DC prediction mode, the planar prediction mode, the directional prediction mode whose mode serial number is the first serial number, and the directional prediction mode whose mode serial number is the second serial number is the planar prediction mode, the planar prediction mode is determined as the intra-frame prediction mode of the current PU.

When an intra-frame prediction mode having a minimum rate-distortion cost among the DC prediction mode, the planar prediction mode, the directional prediction mode whose mode serial number is the first serial number, and the directional prediction mode whose mode serial number is the second serial number is the directional prediction mode (the directional prediction mode whose mode serial number is the first serial number or the directional prediction mode whose mode serial number is the second serial number), a rate-distortion cost of the current PU in a directional prediction mode of another mode serial number is determined, and a first prediction mode is determined as the intra-frame prediction mode of the current PU.

The first prediction mode is a directional prediction mode having a minimum rate-distortion cost among the directional prediction modes corresponding to all the mode serial numbers.

The directional prediction mode whose mode serial number is the first serial number may be a directional prediction mode in a horizontal direction among all the directional prediction modes, and the directional prediction mode whose mode serial number is the second serial number may be a directional prediction mode in a vertical direction among all the directional prediction modes.

For example, in the HEVC/H.265 standard, the directional prediction mode whose mode serial number is the first serial number may be an HO prediction mode whose serial number is 10. In this case, the first serial number is 10. The directional prediction mode whose mode serial number is the second serial number may be a VO prediction mode whose serial number is 26. In this case, the second serial number is 26.

In some feasible implementations, if the unit category of the current PU is the second category, it indicates that the texture of the area in which the neighborhood PU of the current PU is located has apparent and relatively consistent directionality, which further indicates a high possibility that the texture of the area in which the current PU is located has directionality similar to that of the area in which the neighborhood PU is located. In this case, a rate-distortion cost of the current PU in a directional prediction mode corresponding to each neighborhood PU may be determined. An intra-frame prediction mode having a minimum rate-distortion cost among the directional prediction modes corresponding to the neighborhood PUs is determined as the intra-frame prediction mode of the current PU.

In an embodiment, if the unit category of the current PU is the second category, the current PU still has a possibility of not having apparent directionality. In this case, rate-distortion costs of the current PU in the DC prediction mode, the planar prediction mode, and the directional prediction mode corresponding to each neighborhood PU may be determined.

When an intra-frame prediction mode having a minimum rate-distortion cost in the rate-distortion costs in the DC prediction mode, the planar prediction mode, and the directional prediction mode corresponding to each neighborhood PU is the directional prediction mode, a second prediction mode is determined as a directional prediction mode having a minimum rate-distortion cost among the directional prediction modes corresponding to all the neighborhood PUs.

The second prediction mode is a directional prediction mode having a minimum rate-distortion cost among the directional prediction modes corresponding to all the neighborhood PUs.

When the intra-frame prediction mode having the minimum rate-distortion cost in the rate-distortion costs in the DC prediction mode, the planar prediction mode, and the directional prediction mode corresponding to each neighborhood PU is the DC prediction mode or the planar prediction mode, it indicates that texture of the area in which the current PU is located may be inconsistent with texture of the area in which the neighborhood PU is located. Therefore, a rate-distortion cost of the current PU in a directional prediction mode corresponding to another mode serial number may be determined. In this way, a third prediction mode may be determined as the intra-frame prediction mode of the current PU.

The third prediction mode is an intra-frame prediction mode having a minimum rate-distortion cost among the DC prediction mode, the planar prediction mode, and all other directional prediction modes than the directional prediction modes corresponding to all the neighborhood PUs.

In some feasible implementations, if the unit category of the current PU is the third category, whether the current PU has apparent directionality cannot be determined. In this case, rate-distortion costs of the current PU in the DC prediction mode, the planar prediction mode, and all the directional prediction modes may be determined.

Further, a fourth prediction mode may be determined as the intra-frame prediction mode of the current PU. The fourth prediction mode is an intra-frame prediction mode having a minimum rate-distortion cost among the DC prediction mode, the planar prediction mode, and all the directional prediction modes.

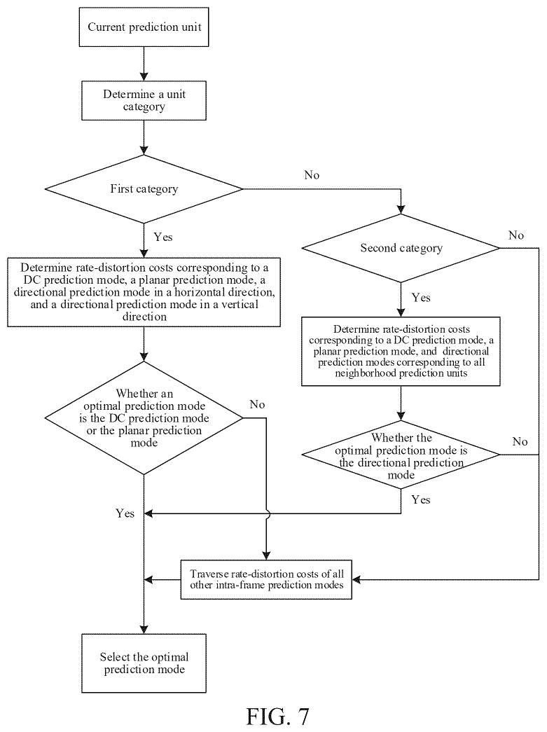

As an example, the following exemplarily describes determination of an intra-frame prediction mode of a current PU with reference to FIG. 7. FIG. 7 is a schematic block diagram of a process of determining an intra-frame prediction mode according to an embodiment of this application. As shown in FIG. 7, for a current PU:

Operation 1: First, PU distribution information of an image block in which the current PU is located is determined, and further, a unit category of the current PU is determined according to the PU distribution information of the image block.

Operation 2: Determine whether a unit category of the current PU is a first category after the unit category of the current PU is determined; and perform operation 3 if the unit category of the current PU is the first category; otherwise, perform operation 4.

Operation 3: Determine rate-distortion costs of the current PU in a DC prediction mode, a planar prediction mode, a directional prediction mode in a horizontal direction, and a directional prediction mode in a vertical direction;
determine an intra-frame prediction mode having a minimum rate-distortion cost as the intra-frame prediction mode of the current PU if the intra-frame prediction mode having the minimum rate-distortion cost among the DC prediction mode, the planar prediction mode, the directional prediction mode in the horizontal direction, and the directional prediction mode in the vertical direction is the DC prediction mode or the planar prediction mode; or
determine rate-distortion costs of the current PU in all other directional prediction modes if an intra-frame prediction mode having a minimum rate-distortion cost among the DC prediction mode, the planar prediction mode, the directional prediction mode in the horizontal direction, and the directional prediction mode in the vertical direction is the directional prediction mode; and further, determine a directional prediction mode having a minimum rate-distortion cost among all the directional prediction modes as the intra-frame prediction mode of the current PU.

Operation 4: Determine whether the unit category of the current PU is a second category when the unit category of the current PU is not the first category; and perform operation 5 if the unit category of the current PU is the second category; otherwise, perform operation 6.

Operation 5: Determine rate-distortion costs of the current PU in the DC prediction mode, the planar prediction mode, and the directional prediction mode corresponding to each neighborhood PU; and determine a directional prediction mode having a minimum rate-distortion cost among the directional prediction modes corresponding to all the neighborhood PUs as the intra-frame prediction mode of the current PU if an intra-frame prediction mode having a minimum rate-distortion cost among the DC prediction mode, the planar prediction mode, and the directional prediction mode corresponding to each neighborhood PU is the directional prediction mode; or
determine rate-distortion costs of the current PU in all other directional prediction modes than the directional prediction modes corresponding to all the neighborhood PUs if an intra-frame prediction mode having a minimum rate-distortion cost among the DC prediction mode, the planar prediction mode, and the directional prediction mode corresponding to each neighborhood PU is the DC prediction mode or the planar prediction mode, and determine an intra-frame prediction mode having a minimum rate-distortion cost among the DC prediction mode, the planar prediction mode, and all other directional prediction modes than the directional prediction modes corresponding to all the neighborhood PUs as the intra-frame prediction mode of the current PU.

Operation 6: Determine rate-distortion costs of the current PU in the DC prediction mode, the planar prediction mode, and all the directional prediction modes if the unit category of the current PU is a third category; and
further, determine an intra-frame prediction mode having a minimum rate-distortion cost among the DC prediction mode, the planar prediction mode, and all the directional prediction modes as the intra-frame prediction mode of the current PU.

In the embodiments of this application, for each current PU, after the unit category of the current PU is determined according to the PU distribution information of the image block in which the current PU is located, the intra-frame prediction mode of the current PU may be directly determined according to the unit category of the current PU, whereby an optimal intra-frame prediction mode may be determined without traversing all intra-frame prediction modes for the current PU. In addition, based on the unit category of the current PU, different video encoding methods may be adopted according to a texture difference between the area in which the current PU is located and the area in which the neighborhood PU is located, which effectively reduces a proportion of intra-frame predictive encoding in video encoding complexity, reduces encoding complexity, saves computing resources, improves video encoding efficiency, and achieves high applicability.

In some feasible implementations, for a video frame, an intra-frame prediction mode of each PU in the video frame may be determined by using the foregoing method, and then intra-frame predictive encoding is performed based on the intra-frame prediction mode of each PU, to further encode video data based on the foregoing implementation.

Specifically, the video frame may be partitioned into non-overlapping CUs, and each CU is partitioned into non-overlapping PUs. Further, by using a spatial correlation and a temporal correlation between video frames, inter-frame prediction and intra-frame prediction based on an intra-frame prediction mode are respectively performed to remove temporal spatial redundant information, to obtain a predicted image block. Further, a predicted residual block is obtained by subtracting the predicted image block from an original image block, and then discrete cosine transform (DCT) and quantization are performed on the predicted residual block, to obtain a quantized DCT coefficient. Finally, entropy encoding is performed on the quantized DCT coefficient, to obtain a compressed bitstream, namely, encoded video data.

The encoded video data may be transmitted to a corresponding streaming media device, and the streaming media performs video playback based on the encoded video data. Alternatively, the encoded video data may be stored in a specified storage space, whereby the encoded video data can be directly acquired from the specified storage space when the video data needs to be encoded.

The specified storage space includes, but is not limited to, cloud storage, a database, a blockchain, a storage space of a device that performs a model training task, and the like. Specifically, the specified storage space may be determined based on requirements of a practical application scenario. This is not limited herein.

The database may be briefly considered as an electronic file cabinet, namely, a place for storing an electronic file, and may be a relational database (structured query language (SQL) database) or a non-relational database (NoSQL database). This is not limited herein. In this application, the database may be configured to store the encoded video data and the rate-distortion cost of each PU in each intra-frame prediction mode. The blockchain is a new application mode of computer technology such as distributed data storage, peer-to-peer transmission, a consensus mechanism, an encryption algorithm, or the like. The blockchain is essentially a decentralized database, and is a string of data blocks generated through association by using a cryptography method. In the embodiments of this application, each data block in the blockchain may store encoded video data and the rate-distortion cost of each PU in each intra-frame prediction mode. The cloud storage is a new concept extended and developed from a cloud computing concept, and refers to aggregating, by using functions such as a cluster application, a mesh technology, and a distributed file storage system and by using application software or an application interface, a large quantity of storage devices (which are also referred to as storage nodes) of different types in a network to work together, to jointly store the encoded video data and the rate-distortion cost of each PU in each intra-frame prediction mode.

Computing processes involved in the embodiments of this application, such as computing of rate-distortion costs and determination of neighborhood prediction units, may be implemented based on a cloud computing technology in the field of cloud technologies, to improve computing efficiency.

The cloud technology is a hosting technology that unifies a series of resources such as hardware, software, and networks in a wide area network or a local area network to implement computing, storage, processing, and sharing of data. The cloud technology, a general term for network technology, information technology, integration technology, management platform technology, and application technology that are applied based on a business mode of cloud computing, may form a resource pool and may be used on demand, which is flexible and convenient. The cloud computing technology will become an important support. Backend services of a technical network system require massive computing and storage resources, such as a video website, a picture website, and another portal website. With the rapid development and application of the Internet industry, each item may have its own identification mark in the future, and the identification marks need to be transmitted to a backend system for logical processing. Data of different levels is processed separately, and all kinds of industry data require a strong system support, which can be achieved only through the cloud computing.

The cloud computing is a computing mode, and is a product of development and convergence of conventional computer and network technologies such as grid computing, distributed computing, parallel computing, utility computing, network storage technologies, virtualization, and load balance. The cloud computing distributes a computing task to a resource pool including a large quantity of computers, whereby various application systems can obtain computing power, storage space, and information services based on requirements. A network providing a resource is referred to as a “cloud”. The resource in the “cloud” can be infinitely extended, can be acquired at any moment, used as required, extended at any moment, and paid for use.

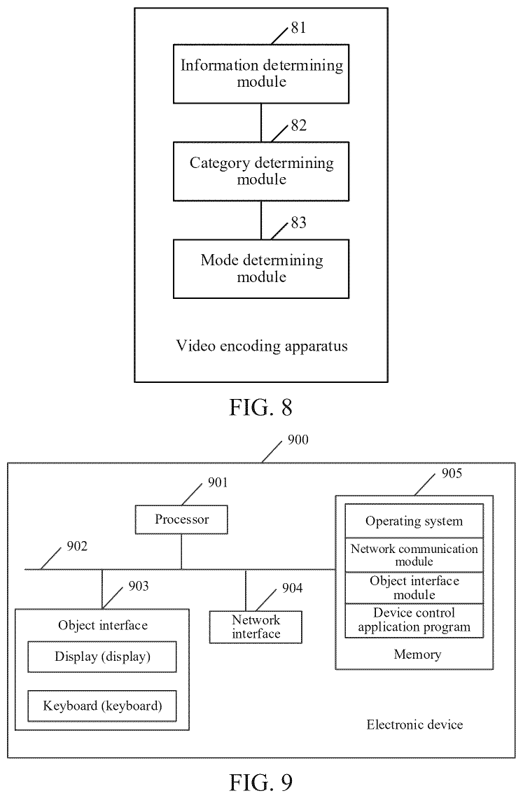

FIG. 8 is a schematic structural diagram of a video encoding apparatus according to an embodiment of this application. The video encoding apparatus provided in the embodiments of this application includes:
an information determining module, configured to determine PU distribution information of an image block in which a current PU is located;
a category determining module, configured to determine a unit category of the current PU according to the PU distribution information of the image block; and
a mode determining module, configured to determine an intra-frame prediction mode of the current PU according to the unit category of the current PU.

In some feasible implementations, when determining a unit category of the current PU according to the PU distribution information of the image block, the category determining module is configured to:
determine the unit category of the current PU according to encoding information of each neighborhood PU in response to that it is determined, according to the PU distribution information of the image block, that a neighborhood PU exists at each preset relative position with respect to the current PU in the image block.

In some feasible implementations, when determining the unit category of the current PU according to encoding information of each neighborhood PU, the category determining module is configured to:
determine that the unit category of the current PU is a first category in response to that it is determined, according to the encoding information of each neighborhood PU, that an intra-frame prediction mode of the corresponding neighborhood PU is a DC prediction mode or a planar prediction mode; or
determine that the unit category of the current PU is a second category in response to that it is determined, according to the encoding information of each neighborhood PU, that intra-frame prediction modes of all the neighborhood PUs are directional prediction modes, and a difference between a maximum mode serial number and a minimum mode serial number corresponding to the directional prediction modes of all the neighborhood PUs is less than or equal to a first threshold.

In some feasible embodiments, the category determining module is further configured to:
determine that the unit category of the current PU is a third category in response to that it is determined, according to the encoding information of each neighborhood PU, that the intra-frame prediction modes of all the neighborhood PUs include at least the DC prediction mode and the directional prediction mode, or include at least the planar prediction mode and the directional prediction mode; or
determine that the unit category of the current PU is a third category in response to that it is determined, according to the encoding information of each neighborhood PU, that the intra-frame prediction modes of all the neighborhood PUs are the directional prediction modes, and the difference between the maximum mode serial number and the minimum mode serial number corresponding to the directional prediction modes of all the neighborhood PUs is greater than the first threshold.

In some feasible embodiments, the category determining module is further configured to:
determine that the unit category of the current PU is the third category in response to that it is determined, according to the PU distribution information of the image block, that no neighborhood PU exists at at least one preset relative position with respect to the current PU in the image block.

In some feasible implementations, the unit category of the current PU is the first category; and
when determining an intra-frame prediction mode of the current PU according to the unit category of the current PU, the mode determining module is configured to:
determine rate-distortion costs of the current PU in the DC prediction mode, the planar prediction mode, a directional prediction mode whose mode serial number is a first serial number, and a directional prediction mode whose mode serial number is a second serial number, respectively; and
determine an intra-frame prediction mode having a minimum rate-distortion cost as the intra-frame prediction mode of the current PU in response to that the intra-frame prediction mode having the minimum rate-distortion cost among the DC prediction mode, the planar prediction mode, the directional prediction mode whose mode serial number is the first serial number, and the directional prediction mode whose mode serial number is the second serial number is the DC prediction mode or the planar prediction mode; or
determine a first prediction mode as the intra-frame prediction mode of the current PU in response to that an intra-frame prediction mode having a minimum rate-distortion cost among the DC prediction mode, the planar prediction mode, the directional prediction mode whose mode serial number is the first serial number, and the directional prediction mode whose mode serial number is the second serial number is the directional prediction mode, the first prediction mode being a directional prediction mode having a minimum rate-distortion cost among the directional prediction modes corresponding to all mode serial numbers.

In some feasible implementations, the unit category of the current PU is the second category; and
when determining an intra-frame prediction mode of the current PU according to the unit category of the current PU, the mode determining module is configured to:
determine rate-distortion costs of the current PU in the DC prediction mode, the planar prediction mode, and the directional prediction mode corresponding to each neighborhood PU, respectively; and
determine a second prediction mode as the intra-frame prediction mode of the current PU in response to that an intra-frame prediction mode having a minimum rate-distortion cost among the DC prediction mode, the planar prediction mode, and the directional prediction mode corresponding to each neighborhood PU is the directional prediction mode, the second prediction mode being a directional prediction mode having a minimum rate-distortion cost among the directional prediction modes corresponding to all the neighborhood PUs; or
determine a third prediction mode as the intra-frame prediction mode of the current PU in response to that an intra-frame prediction mode having a minimum rate-distortion cost among the DC prediction mode, the planar prediction mode, and the directional prediction mode corresponding to each neighborhood PU is the DC prediction mode or the planar prediction mode, the third prediction mode being an intra-frame prediction mode having a minimum rate-distortion cost among the DC prediction mode, the planar prediction mode, and all other directional prediction modes than the directional prediction modes corresponding to all the neighborhood PUs.

In some feasible implementations, the unit category of the current PU is the third category; and
when determining an intra-frame prediction mode of the current PU according to the unit category of the current PU, the mode determining module is configured to:
determine rate-distortion costs of the current PU in the DC prediction mode, the planar prediction mode, and all the directional prediction modes, respectively; and
determine a fourth prediction mode as the intra-frame prediction mode of the current PU, the fourth prediction mode being an intra-frame prediction mode having a minimum rate-distortion cost among the DC prediction mode, the planar prediction mode, and all the directional prediction modes.

During specific implementation, the apparatus may perform implementations provided in the operations in FIG. 2 by using built-in functional modules of the apparatus. For details, refer to the implementations provided in the operations. Details are not described herein again.

FIG. 9 is a schematic structural diagram of an electronic device according to an embodiment of this application. As shown in FIG. 9, an electronic device 900 in this embodiment may include: a processor 901, a network interface 904, and a memory 905. In addition, the electronic device 900 may further include: an object interface 903 and at least one communication bus 902. The communications bus 902 is configured to implement connection and communication between these components. The object interface 903 may include a display and a keyboard. In an embodiment, the object interface 903 may further include a standard wired or wireless interface. In an embodiment, the network interface 904 may include a standard wired or wireless interface (such as a wireless fidelity (Wi-Fi) interface). The memory 905 may be a high-speed random-access memory (RAM) memory, or may be a non-volatile memory (NVM), such as at least one magnetic disk memory. In an embodiment, the memory 905 may alternatively be at least one storage apparatus away from the processor 901. As shown in FIG. 9, the memory 905, as a non-transitory computer-readable storage medium, may have an operating system, a network communication module, an object interface module, and a device control application program stored therein.

In the electronic device 900 shown in FIG. 9, the network interface 904 may provide a network communication function. The object interface 903 is mainly configured to provide an input interface for a user. The processor 901 may be configured to invoke the device control application program stored in the memory 905 to implement:
determining PU distribution information of an image block in which a current PU is located;
determining a unit category of the current PU according to the PU distribution information of the image block; and
determining an intra-frame prediction mode of the current PU according to the unit category of the current PU.

In some feasible implementations, when determining a unit category of the current PU according to the PU distribution information of the image block, the processor 901 is configured to:
determine the unit category of the current PU according to encoding information of each neighborhood PU in response to that it is determined, according to the PU distribution information of the image block, that a neighborhood PU exists at each preset relative position with respect to the current PU in the image block.

In some feasible implementations, when determining the unit category of the current PU according to encoding information of each neighborhood PU, the processor 901 is configured to:
determine that the unit category of the current PU is a first category in response to that it is determined, according to the encoding information of each neighborhood PU, that an intra-frame prediction mode of the corresponding neighborhood PU is a DC prediction mode or a planar prediction mode; or
determine that the unit category of the current PU is a second category in response to that it is determined, according to the encoding information of each neighborhood PU, that intra-frame prediction modes of all the neighborhood PUs are directional prediction modes, and a difference between a maximum mode serial number and a minimum mode serial number corresponding to the directional prediction modes of all the neighborhood PUs is less than or equal to a first threshold.

In some feasible implementations, the processor 901 is further configured to:
determine that the unit category of the current PU is a third category in response to that it is determined, according to the encoding information of each neighborhood PU, that the intra-frame prediction modes of all the neighborhood PUs include at least the DC prediction mode and the directional prediction mode, or include at least the planar prediction mode and the directional prediction mode; or
determine that the unit category of the current PU is a third category in response to that it is determined, according to the encoding information of each neighborhood PU, that the intra-frame prediction modes of all the neighborhood PUs are the directional prediction modes, and the difference between the maximum mode serial number and the minimum mode serial number corresponding to the directional prediction modes of all the neighborhood PUs is greater than the first threshold.

In some feasible implementations, the processor 901 is further configured to:
determine that the unit category of the current PU is the third category in response to that it is determined, according to the PU distribution information of the image block, that no neighborhood PU exists at at least one preset relative position with respect to the current PU in the image block.

In some feasible implementations, the unit category of the current PU is the first category; and
when determining an intra-frame prediction mode of the current PU according to the unit category of the current PU, the processor 901 is configured to:
determine rate-distortion costs of the current PU in the DC prediction mode, the planar prediction mode, a directional prediction mode whose mode serial number is a first serial number, and a directional prediction mode whose mode serial number is a second serial number, respectively; and
determine an intra-frame prediction mode having a minimum rate-distortion cost as the intra-frame prediction mode of the current PU in response to that the intra-frame prediction mode having the minimum rate-distortion cost among the DC prediction mode, the planar prediction mode, the directional prediction mode whose mode serial number is the first serial number, and the directional prediction mode whose mode serial number is the second serial number is the DC prediction mode or the planar prediction mode; or
determine a first prediction mode as the intra-frame prediction mode of the current PU in response to that an intra-frame prediction mode having a minimum rate-distortion cost among the DC prediction mode, the planar prediction mode, the directional prediction mode whose mode serial number is the first serial number, and the directional prediction mode whose mode serial number is the second serial number is the directional prediction mode, the first prediction mode being a directional prediction mode having a minimum rate-distortion cost among the directional prediction modes corresponding to all mode serial numbers.

In some feasible implementations, the unit category of the current PU is the second category; and
when determining an intra-frame prediction mode of the current PU according to the unit category of the current PU, the processor 901 is configured to:
determine rate-distortion costs of the current PU in the DC prediction mode, the planar prediction mode, and the directional prediction mode corresponding to each neighborhood PU, respectively; and
determine a second prediction mode as the intra-frame prediction mode of the current PU in response to that an intra-frame prediction mode having a minimum rate-distortion cost among the DC prediction mode, the planar prediction mode, and the directional prediction mode corresponding to each neighborhood PU is the directional prediction mode, the second prediction mode being a directional prediction mode having a minimum rate-distortion cost among the directional prediction modes corresponding to all the neighborhood PUs; or
determine a third prediction mode as the intra-frame prediction mode of the current PU in response to that an intra-frame prediction mode having a minimum rate-distortion cost among the DC prediction mode, the planar prediction mode, and the directional prediction mode corresponding to each neighborhood PU is the DC prediction mode or the planar prediction mode, the third prediction mode being an intra-frame prediction mode having a minimum rate-distortion cost among the DC prediction mode, the planar prediction mode, and all other directional prediction modes than the directional prediction modes corresponding to all the neighborhood PUs.

In some feasible implementations, the unit category of the current PU is the third category; and
when determining an intra-frame prediction mode of the current PU according to the unit category of the current PU, the processor 901 is configured to:
determine rate-distortion costs of the current PU in the DC prediction mode, the planar prediction mode, and all the directional prediction modes, respectively; and
determine a fourth prediction mode as the intra-frame prediction mode of the current PU, the fourth prediction mode being an intra-frame prediction mode having a minimum rate-distortion cost among the DC prediction mode, the planar prediction mode, and all the directional prediction modes.

In some feasible implementations, the processor 901 may be a central processing unit (CPU), or the processor may be another general-purpose processor, a digital signal processor (DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like. The memory may include a read-only memory (ROM) and an RAM, and provides instructions and data for the processor. A portion of the memory may further include a non-volatile RAM. For example, the memory may further store information about a device type.

During specific implementation, the electronic device 900 may perform implementations provided in the operations in FIG. 2 by using built-in functional modules of the electronic device. For details, refer to the implementations provided in the operations. Details are not described herein again.

The embodiments of this application further provide a non-transitory computer-readable storage medium, which has a computer program stored therein. A processor executes the computer program to implement the method provided in the operations in FIG. 2. For details, refer to the implementations provided in the operations. Details are not described herein again.

The computer-readable storage medium may be an internal storage unit in the video encoding apparatus or electronic device provided in any one of the foregoing embodiments, such as a hard disk or an internal memory of the electronic device. The computer-readable storage medium may alternatively be an external storage device of the electronic device, such as a plug-in hard disk, a smart media card (SMC), a secure digital (SD) card, or a flash card equipped on the electronic device. The computer-readable storage medium may further include a magnetic disk, an optical disc, an ROM, an RAM, or the like. Further, the computer-readable storage medium may further include both an internal storage unit and an external storage device of the electronic device. The computer-readable storage medium is configured to store the computer program and another program and data required by the electronic device. The computer-readable storage medium may be further configured to temporarily store data that has been outputted or is to be outputted.

The embodiments of this application provide a computer program product, which includes a computer program. A processor executes the computer program to perform the method provided in the operations in FIG. 2.

The terms “first”, “second”, and the like in the claims, the description, and the drawings of this application are intended to distinguish between different objects, instead of describing a particular sequence. In addition, the terms “include”, “have”, and any variant thereof are intended to cover a non-exclusive inclusion. For example, a process, method, system, product, or electronic device including a series of operations or units is not limited to the listed operations or units, but instead, in an embodiment, further includes operations or units that are not listed, or in an embodiment, includes other operations or units inherent to the process, method, product, or electronic device. “Embodiment” mentioned herein means that particular features, structures, or characteristics described with reference to the embodiment may be included in at least one embodiment of this application. The phrase presented at various positions in the description may not necessarily refer to a same embodiment, and is not an independent or alternative embodiment exclusive from another embodiment. Those skilled in the art explicitly or implicitly understands that the embodiments described herein may be combined with other embodiments. The term “and/or” used in the description and the appended claims of this application refers to any and all possible combinations of one or more of associated listed items, and includes these combinations.

Those of ordinary skill in the art may realize that, exemplar units and algorithm operations described with reference to the disclosed embodiments herein can be implemented by electronic hardware, computer software, or a combination thereof. To clearly describe the interchangeability between the hardware and the software, exemplar compositions and operations have been generally described based on functions in the foregoing descriptions. Those skilled in the art may use different methods to implement the described functions for each particular application, but such implementations are not to be considered beyond the scope of this application.

Merely exemplary embodiments of this application are disclosed above, and certainly are not intended to limit the scope of the claims of this application. Therefore, equivalent variations made in accordance with the claims of this application still fall within the scope of this application.

In the embodiments of this application, the term “module” or “unit” refers to a computer program with a preset function or a part of the computer program and works, together with other related parts, to implement a preset target, and may be completely or partially implemented by using software, hardware (such as a processing circuit or a memory) or a combination thereof. Similarly, one processor (or a plurality of processors or memories) may be configured to implement one or more modules or units. In addition, each module or unit may be a part of an overall module or unit including a function of the module or unit.

What is claimed is:

1. A video encoding method performed by an electronic device and comprising:
determining prediction unit (PU) distribution information of an image block in which a current PU is located, wherein the PU distribution information of the image block represents a partitioning method and distribution of neighboring PUs of the current PU in the image block;
determining a unit category of the current PU according to the PU distribution information of the image block;
determining an intra-frame prediction mode of the current PU according to the unit category of the current PU; and
encoding the image block using the current PU according to the determined intra-frame prediction mode.

2. The method according to claim 1, wherein the determining a unit category of the current PU according to the PU distribution information of the image block comprises:
determining the unit category of the current PU according to encoding information of each neighborhood PU in response to that it is determined, according to the PU distribution information of the image block, that a neighborhood PU exists at each preset relative position with respect to the current PU in the image block.

3. The method according to claim 2, wherein the determining the unit category of the current PU according to encoding information of each neighborhood PU comprises:
determining that the unit category of the current PU is a first category in response to that it is determined, according to the encoding information of each neighborhood PU, that an intra-frame prediction mode of the corresponding neighborhood PU is a direct current (DC) prediction mode or a planar prediction mode; or
determining that the unit category of the current PU is a second category in response to that it is determined, according to the encoding information of each neighborhood PU, that intra-frame prediction modes of all the neighborhood PUs are directional prediction modes, and a difference between a maximum mode serial number and a minimum mode serial number corresponding to the directional prediction modes of all the neighborhood PUs is less than or equal to a first threshold.

4. The method according to claim 1, further comprising:
determining that the unit category of the current PU is a third category in response to that it is determined, according to the encoding information of each neighborhood PU, that the intra-frame prediction modes of all the neighborhood PUs comprise at least the DC prediction mode and the directional prediction mode, or comprise at least the planar prediction mode and the directional prediction mode; or
determining that the unit category of the current PU is a third category in response to that it is determined, according to the encoding information of each neighborhood PU, that the intra-frame prediction modes of all the neighborhood PUs are the directional prediction modes, and the difference between the maximum mode serial number and the minimum mode serial number corresponding to the directional prediction modes of all the neighborhood PUs is greater than the first threshold.

5. The method according to claim 1, further comprising:
determining that the unit category of the current PU is the third category in response to that it is determined, according to the PU distribution information of the image block, that no neighborhood PU exists at at least one preset relative position with respect to the current PU in the image block.

6. The method according to claim 1, wherein the unit category of the current PU is the first category; and
the determining an intra-frame prediction mode of the current PU according to the unit category of the current PU comprises:
determining rate-distortion costs of the current PU in the DC prediction mode, the planar prediction mode, a directional prediction mode whose mode serial number is a first serial number, and a directional prediction mode whose mode serial number is a second serial number, respectively; and
determining an intra-frame prediction mode having a minimum rate-distortion cost as the intra-frame prediction mode of the current PU in response to that the intra-frame prediction mode having the minimum rate-distortion cost among the DC prediction mode, the planar prediction mode, the directional prediction mode whose mode serial number is the first serial number, and the directional prediction mode whose mode serial number is the second serial number is the DC prediction mode or the planar prediction mode; or
determining a first prediction mode as the intra-frame prediction mode of the current PU in response to that an intra-frame prediction mode having a minimum rate-distortion cost among the DC prediction mode, the planar prediction mode, the directional prediction mode whose mode serial number is the first serial number, and the directional prediction mode whose mode serial number is the second serial number is the directional prediction mode, the first prediction mode being a directional prediction mode having a minimum rate-distortion cost among the directional prediction modes corresponding to all mode serial numbers.

7. The method according to claim 1, wherein the unit category of the current PU is the second category; and
the determining an intra-frame prediction mode of the current PU according to the unit category of the current PU comprises:
determining rate-distortion costs of the current PU in the DC prediction mode, the planar prediction mode, and the directional prediction mode corresponding to each neighborhood PU, respectively; and
determining a second prediction mode as the intra-frame prediction mode of the current PU in response to that an intra-frame prediction mode having a minimum rate-distortion cost among the DC prediction mode, the planar prediction mode, and the directional prediction mode corresponding to each neighborhood PU is the directional prediction mode, the second prediction mode being a directional prediction mode having a minimum rate-distortion cost among the directional prediction modes corresponding to all the neighborhood PUs; or
determining a third prediction mode as the intra-frame prediction mode of the current PU in response to that an intra-frame prediction mode having a minimum rate-distortion cost among the DC prediction mode, the planar prediction mode, and the directional prediction mode corresponding to each neighborhood PU is the DC prediction mode or the planar prediction mode, the third prediction mode being an intra-frame prediction mode having a minimum rate-distortion cost among the DC prediction mode, the planar prediction mode, and all other directional prediction modes than the directional prediction modes corresponding to all the neighborhood PUs.

8. The method according to claim 1, wherein the unit category of the current PU is the third category; and
the determining an intra-frame prediction mode of the current PU according to the unit category of the current PU comprises:
determining rate-distortion costs of the current PU in the DC prediction mode, the planar prediction mode, and all the directional prediction modes, respectively; and
determining a fourth prediction mode as the intra-frame prediction mode of the current PU, the fourth prediction mode being an intra-frame prediction mode having a minimum rate-distortion cost among the DC prediction mode, the planar prediction mode, and all the directional prediction modes.

9. An electronic device, comprising a processor and a memory, the processor being connected to the memory;
the memory being configured to store a computer program; and
the processor being configured to perform, when invoking the computer program, a video encoding method including:
determining prediction unit (PU) distribution information of an image block in which a current PU is located, wherein the PU distribution information of the image block represents a partitioning method and distribution of neighboring PUs of the current PU in the image block;
determining a unit category of the current PU according to the PU distribution information of the image block;
determining an intra-frame prediction mode of the current PU according to the unit category of the current PU; and
encoding the image block using the current PU according to the determined intra-frame prediction mode.

10. The electronic device according to claim 9, wherein the determining a unit category of the current PU according to the PU distribution information of the image block comprises:
determining the unit category of the current PU according to encoding information of each neighborhood PU in response to that it is determined, according to the PU distribution information of the image block, that a neighborhood PU exists at each preset relative position with respect to the current PU in the image block.

11. The electronic device according to claim 10, wherein the determining the unit category of the current PU according to encoding information of each neighborhood PU comprises:
determining that the unit category of the current PU is a first category in response to that it is determined, according to the encoding information of each neighborhood PU, that an intra-frame prediction mode of the corresponding neighborhood PU is a direct current (DC) prediction mode or a planar prediction mode; or
determining that the unit category of the current PU is a second category in response to that it is determined, according to the encoding information of each neighborhood PU, that intra-frame prediction modes of all the neighborhood PUs are directional prediction modes, and a difference between a maximum mode serial number and a minimum mode serial number corresponding to the directional prediction modes of all the neighborhood PUs is less than or equal to a first threshold.

12. The electronic device according to claim 9, wherein the method further comprises:
determining that the unit category of the current PU is a third category in response to that it is determined, according to the encoding information of each neighborhood PU, that the intra-frame prediction modes of all the neighborhood PUs comprise at least the DC prediction mode and the directional prediction mode, or comprise at least the planar prediction mode and the directional prediction mode; or
determining that the unit category of the current PU is a third category in response to that it is determined, according to the encoding information of each neighborhood PU, that the intra-frame prediction modes of all the neighborhood PUs are the directional prediction modes, and the difference between the maximum mode serial number and the minimum mode serial number corresponding to the directional prediction modes of all the neighborhood PUs is greater than the first threshold.

13. The electronic device according to claim 9, wherein the method further comprises:
determining that the unit category of the current PU is the third category in response to that it is determined, according to the PU distribution information of the image block, that no neighborhood PU exists at at least one preset relative position with respect to the current PU in the image block.

14. The electronic device according to claim 9, wherein the unit category of the current PU is the first category; and
the determining an intra-frame prediction mode of the current PU according to the unit category of the current PU comprises:
determining rate-distortion costs of the current PU in the DC prediction mode, the planar prediction mode, a directional prediction mode whose mode serial number is a first serial number, and a directional prediction mode whose mode serial number is a second serial number, respectively; and
determining an intra-frame prediction mode having a minimum rate-distortion cost as the intra-frame prediction mode of the current PU in response to that the intra-frame prediction mode having the minimum rate-distortion cost among the DC prediction mode, the planar prediction mode, the directional prediction mode whose mode serial number is the first serial number, and the directional prediction mode whose mode serial number is the second serial number is the DC prediction mode or the planar prediction mode; or
determining a first prediction mode as the intra-frame prediction mode of the current PU in response to that an intra-frame prediction mode having a minimum rate-distortion cost among the DC prediction mode, the planar prediction mode, the directional prediction mode whose mode serial number is the first serial number, and the directional prediction mode whose mode serial number is the second serial number is the directional prediction mode, the first prediction mode being a directional prediction mode having a minimum rate-distortion cost among the directional prediction modes corresponding to all mode serial numbers.

15. The electronic device according to claim 9, wherein the unit category of the current PU is the second category; and
the determining an intra-frame prediction mode of the current PU according to the unit category of the current PU comprises:
determining rate-distortion costs of the current PU in the DC prediction mode, the planar prediction mode, and the directional prediction mode corresponding to each neighborhood PU, respectively; and
determining a second prediction mode as the intra-frame prediction mode of the current PU in response to that an intra-frame prediction mode having a minimum rate-distortion cost among the DC prediction mode, the planar prediction mode, and the directional prediction mode corresponding to each neighborhood PU is the directional prediction mode, the second prediction mode being a directional prediction mode having a minimum rate-distortion cost among the directional prediction modes corresponding to all the neighborhood PUs; or
determining a third prediction mode as the intra-frame prediction mode of the current PU in response to that an intra-frame prediction mode having a minimum rate-distortion cost among the DC prediction mode, the planar prediction mode, and the directional prediction mode corresponding to each neighborhood PU is the DC prediction mode or the planar prediction mode, the third prediction mode being an intra-frame prediction mode having a minimum rate-distortion cost among the DC prediction mode, the planar prediction mode, and all other directional prediction modes than the directional prediction modes corresponding to all the neighborhood PUs.

16. The electronic device according to claim 9, wherein the unit category of the current PU is the third category; and
the determining an intra-frame prediction mode of the current PU according to the unit category of the current PU comprises:
determining rate-distortion costs of the current PU in the DC prediction mode, the planar prediction mode, and all the directional prediction modes, respectively; and
determining a fourth prediction mode as the intra-frame prediction mode of the current PU, the fourth prediction mode being an intra-frame prediction mode having a minimum rate-distortion cost among the DC prediction mode, the planar prediction mode, and all the directional prediction modes.

17. A non-transitory computer-readable storage medium having a computer program stored therein, wherein the computer program, when executed by a processor of an electronic device, causes the electronic device to implement a video encoding method including:
determining prediction unit (PU) distribution information of an image block in which a current PU is located, wherein the PU distribution information of the image block represents a partitioning method and distribution of neighboring PUs of the current PU in the image block;
determining a unit category of the current PU according to the PU distribution information of the image block;
determining an intra-frame prediction mode of the current PU according to the unit category of the current PU; and
encoding the image block using the current PU according to the determined intra-frame prediction mode.

18. The non-transitory computer-readable storage medium according to claim 17, wherein the determining a unit category of the current PU according to the PU distribution information of the image block comprises:
determining the unit category of the current PU according to encoding information of each neighborhood PU in response to that it is determined, according to the PU distribution information of the image block, that a neighborhood PU exists at each preset relative position with respect to the current PU in the image block.

19. The non-transitory computer-readable storage medium according to claim 17, wherein the method further comprises:
determining that the unit category of the current PU is a third category in response to that it is determined, according to the encoding information of each neighborhood PU, that the intra-frame prediction modes of all the neighborhood PUs comprise at least the DC prediction mode and the directional prediction mode, or comprise at least the planar prediction mode and the directional prediction mode; or
determining that the unit category of the current PU is a third category in response to that it is determined, according to the encoding information of each neighborhood PU, that the intra-frame prediction modes of all the neighborhood PUs are the directional prediction modes, and the difference between the maximum mode serial number and the minimum mode serial number corresponding to the directional prediction modes of all the neighborhood PUs is greater than the first threshold.

20. The non-transitory computer-readable storage medium according to claim 17, wherein the method further comprises:
determining that the unit category of the current PU is the third category in response to that it is determined, according to the PU distribution information of the image block, that no neighborhood PU exists at at least one preset relative position with respect to the current PU in the image block.
